(19) United States
(12) Patent Application Publication
(10) Pub. No.: US 2005/0275396 A1
(43) Pub. Date: Dec. 15, 2005

(54) Sample analyzer and external memory for use in sample analyzer

(75) Inventors: Rumi Kitani, Kobe (JP); Takamichi Naito, Kobe (JP)

Correspondence Address: SUGHRUE MION, PLLC, 2100 PENNSYLVANIA AVENUE, N.W., SUITE 800, WASHINGTON, DC, 20037, US

(73) Assignee: SYSMEX CORPORATION

(21) Appl. No.: 11/147,296

(22) Filed: Jun. 8, 2005

(30) Foreign Application Priority Data
Jun. 9, 2004 (JP) 2004-170620

(51) Int. Cl. G06F 19/00

(52) U.S. Cl. 324/76.61

(57) ABSTRACT

A sample analyzer including an internal memory installed within a device body and which includes a storage region including a sector for storing predetermined type of information related to an analysis of sample; and an external memory removably installed from outside the device body, for storing a program used in the analysis of sample, and sector modification information for modifying the range of the sector in the storage region. An external memory is also disclosed.

### FIELD OF THE INVENTION

The present invention relates to a sample analyzer and an external memory for use in a sample analyzer, and specifically relates to a sample analyzer provided with an internal memory having a storage region for storing information related to an analysis of sample, and an external memory for use by the analyzer.

### BACKGROUND

Sample analyzers are known which are capable of analyzing samples by executing control programs stored on a memory card removably loaded from outside the device body. Such sample analyzers include analyzers that execute control programs stored on a memory card when a memory card is loaded, and that execute control programs stored in ROM (read only memory) when a memory card is not loaded (for example, Japanese Laid-Open Patent Publication No. 8-15267).

In the case of this sample analyzer, when the version of a control program stored in ROM must be updated, the new version of the control program can be executed by loading a memory card.

This sample analyzer, however, completely omits mention of the necessity of modifying the stored content of information relating to analysis, such as analysis results obtained by assaying samples, various setting values, and error history and the like which must be performed in conjunction with the version upgrade of the control program. Furthermore, this sample analyzer also does not address the desire to increase the number of storable analysis results in conjunction with the version upgrade of the control program.

### SUMMARY

The scope of the present invention is defined solely by the appended claims, and is not affected to any degree by the statements within this summary.

An object of the present invention is to facilitate program version upgrades.

A first aspect of the present invention is a sample analyzer that comprises an internal memory installed within a device body and which includes a storage region including a sector for storing predetermined type of information related to an analysis of sample; and an external memory removably installed from outside the device body, for storing a program used in the analysis of sample, and sector modification information for modifying the range of the sector in the storage region.

A second aspect of the present invention is an external memory removably installed from outside a sample analyzer which comprises an internal memory that includes a first storage region including a sector for storing a predetermined kind of information related to an analysis of sample, the external memory comprising a second storage region for storing a program related to the analysis of sample, and sector modification information for modifying the range of the sector in the first storage region.

A third aspect of the present invention is a sample analyzer that comprises an internal memory installed within a device body, for storing information related to an analysis of sample; and an external memory removably installed from outside the device body, for storing a program related to the analysis of sample, and a evacuate program for evacuating the information stored on the internal memory to another memory.

### BRIEF DESCRIPTION OF THE DRAWINGS

FIG. 1 is a perspective view showing the general structure of the blood analyzer of an embodiment of the present invention;

FIG. 2 is a plan view illustrating the structure of the blood analyzer shown in FIG. 1;

FIG. 3 is a plan view illustrating the structure of the BBURAM memory region used by the blood analyzer shown in FIG. 1;

FIG. 4 is a flow chart illustrating the process executed by the CPU when the blood analyzer shown in FIG. 1 is started;

FIG. 5 is a plan view illustrating the structure of the storage region after the application program version upgrade in the BBURAM used in the blood analyzer shown in FIG. 1; and

FIG. 6 is a plan view illustrating the structure of the blood analyzer in a modification of the blood analyzer shown in FIG. 1.

### DETAILED DESCRIPTION OF THE PREFERRED EMBODIMENT

The preferred embodiment of the present invention is described below with reference to the drawings.

The embodiments are described hereinafter based on the drawings. In the embodiments which follow, the sample analyzer of the present invention is described by way of an example of a blood analyzer.

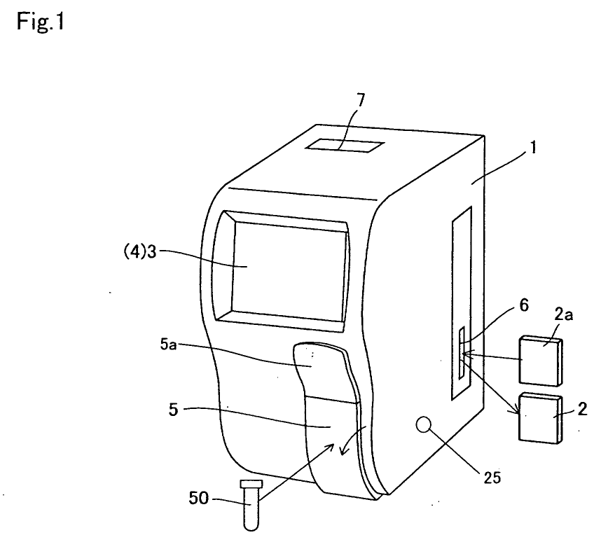

The structure of the blood analyzer of the present embodiment is described first below with reference to FIGS. 1 to 3.

In the blood analyzer of the present embodiment, a device body 1 shown in FIG. 1 has the function of outputting analysis results of the blood specimen (sample) 50, such as WBC (white blood cell count), RBC (red blood cell count), HGB (hemoglobin concentration), HCT (hematocrit value), MCV (mean red cell volume), MCH (mean corpuscular hemoglobin), MCHC (mean corpuscular hemoglobin concentration), PLT (platelet count) and the like. Furthermore, a display unit 3 configured by a liquid crystal screen is provided on the top front side of the device body 1. Various information, such as various setting values and analysis results of the blood specimen 50 are displayed on the display unit 3. The display unit 3 functions as a touch panel, and is integratedly formed with an operation unit 4 for operating the device body 1. Specifically, the liquid crystal screen of the display unit 3 (operation unit 4) displays operation keys for selecting various functions and settings relating to measurements of the blood specimen 50, and is capable of performing operations such as selecting the various functions and settings when the user touches the operations keys on the liquid crystal screen. A specimen placement unit 5 for placing blood specimens 50 is provided on the bottom front side of the device body 1. The specimen placement unit 5 is configured to rotate the specimen placement unit 5 and deliver the blood specimen 50 to a storage unit (not shown in the drawing) when the user presses the operation panel 5a. On the right side panel of the device body 1 is provided a card loader 6 for selectively loading a memory card 2 or memory card 2a such that the memory card 2 or memory card 2a is removable from the device body. The device body 1 is configured so as to be capable of reading from and writing to the memory card 2 (2a) by loading the memory card 2 (2a) in the card loader 6. On the right side panel of the device body 1 is also provided a power switch 25 for turning the power ON and OFF to the device body 1.

An internal printer 7 is provided on the top of the device body 1. The internal printer 7 is provided to print information such as various setting values and analysis results of the blood specimens 50 and the like.

In the present specification, loading a memory card from outside the device body is not limited to memory cards which are directly user accessible from outside the device body. For example, the sample analyzer of the present invention includes sample analyzers in which the device body 1 is provided with a cover to protect the memory card 2 (2a), such that in the normal state the memory card 2 (2a) is inaccessible to the user, and when the memory card 2 (2a) is exchanged, the cover is opened, and a new memory card is loaded.

Although described in detail later, both the memory card 2 and memory card 2a store application programs used in the analysis of the blood samples 50, and an operating system and the like necessary for the operation of the application programs. The application programs stored on the memory card 2a are newer versions of the application programs than the application programs stored on the memory card 2. Accordingly, when a version upgrade of the application programs is required, the memory card 2 is removed from the card loader 6, and the memory card 2a is loaded. The memory card 2 (2a) remains loaded in the card loader 6 while the device body 1 is operating.

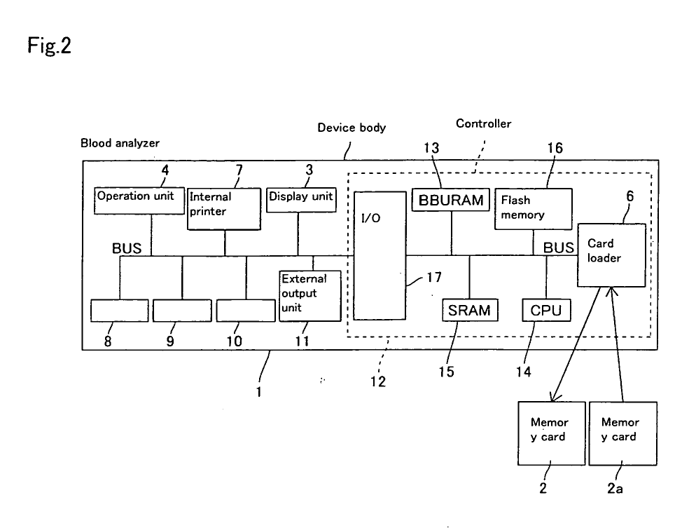

Provided within the device body 1 are a detection unit 8, sample preparation unit 9, washing unit 10, external output unit 11, and controller 12, as shown in FIG. 2. The detection unit 8, sample preparation unit 9, washing unit 10, external output unit 11, controller 12, display unit 3, operation unit 4, and internal printer 7 are connected to a bus which functions as a data transfer path to allow data to be mutually sent and received among the various units.

The sample preparation unit 9 suctions a blood specimen 50 from a specimen container, quantifies the suctioned blood, dilutes the blood and adds reagent, then supplies the sample to the detection unit 8.

The detection unit 8 detects electrical signals from the blood sample 50 supplied from the sample preparation unit 9, converts the detected electrical signals to digital signals, and outputs the digital signals to the controller 12 in order for the controller 12 to calculate the analysis result, such as the number and size of the particles (red blood cells, white blood cells, platelets) in the blood sample.

The washing unit 10 washes the detection unit 8 and sample preparation unit 9 after the blood sample 50 has been measured.

The external output unit 11 is provided to output information, such as the analysis result of the blood specimen 50 calculated by the controller 12 to a peripheral device such as an external printer (not shown in the drawing), and is provided to connect the device body 1 to an external network.

The controller 12 is configured by a BBURAM (battery back-up random access memory; battery back-up RAM) 13 which is backed up by a battery in case the power source turns off, CPU (central processing unit) 14, SRAM (static random access memory) 15, flash memory 16, I/O controller 17, and card loader 6. The BBURAM 13, CPU 14, SRAM 15, flash memory 16, I/O controller 17, and card loader 6 are connected to a bus which functions as a data transfer path to allow data to be sent and received mutually among these units.

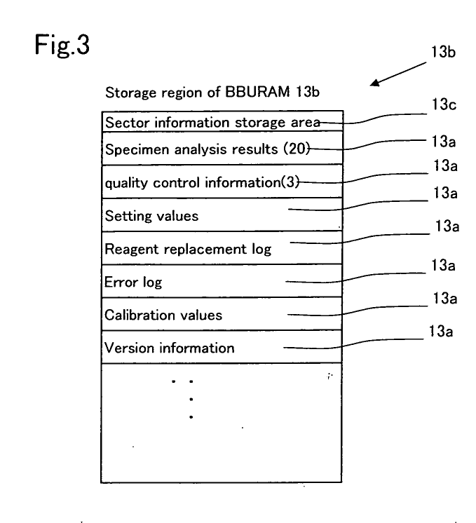

The BBURAM 13 has a memory region 13b which have a plurality of sectors 13a of predetermined capacity and a sector information storage area 13c, as shown in FIG. 3. The starting address and ending address of each sector 13a are stored in the sector information storage area 13c, which sets the range of each sector 13a in the storage region 13b.

Each sector 13a of the storage region 13 stores predetermined type of information relating to the analysis of samples (analysis-linked information). That is, analysis-linked information, such as specimen analysis results, quality control information, setting values, reagent replacement log, error log, calibration values, version information and the like is stored by type in the sectors 13a. The sectors 13a shown in FIG. 3 represent when a memory card 2 is loaded in the card loader 6.

The storage capacity of the BBURAM 13 is 512 kb.

The specimen analysis result is the result of the analysis of the previously measured blood specimen 50. When a memory card 2 is loaded, the sector 13a for storing the specimen analysis result has a capacity capable of storing the specimen analysis results of twenty specimens.

The quality control information is information for managing the accuracy of the blood analyzer, and consists of the analysis result obtained by each measurement of accuracy management blood specimens prepared so as to obtain a predetermined analysis result when measured by the device body 1 on a daily basis. The management of the accuracy of the blood specimen analysis performed by the blood analyzer is accomplished by verifying that the analysis result of the accuracy management blood specimen is within a predetermined range. When a memory card 2 is loaded, the sector 13a which stores the quality control information has a capacity capable of storing the analysis results of three types of accuracy management blood specimens measured within a predetermined range.

The setting values are related to system settings, date settings, and abnormality determination settings of the blood analyzer.

The reagent replacement log contains information indicating the history of reagent replacement within a predetermined time period, and is associated with the type of reagent and the date of reagent replacement for each reagent.

The error log contains information indicating the history of errors generated within a predetermined time period, and associates the type of error and data on which the error occurred.

The calibration values include a calibration value for HGB (hemoglobin concentration), and a calibration value for HCT (hematocrit value). The calibration values are used to calculate accurate hemoglobin concentration and hematocrit value.

The version information (version number) is the version number indicating the version of the application program stored on the memory card 2 (2a). Version information is read from the memory card 2 (2a) and stored in the BBURAM 13 by the CPU 14.

The CPU 14 controls the detection unit 8, sample preparation unit 9, washing unit 10, external output unit 11, display unit 3, and internal printer 7, and performs processes to modify the range of the sectors 13a of the storage region 13b of the BBURAM 13, which is described later.

The SRAM 15 is provided to temporarily store various types of programs (application program, operating system, sector modification program, and save program and the like) which are started by the CPU 14. The various types of programs started by the CPU 14 are loaded in the storage region of the SRAM 15, and then operate from the storage area of the SRAM 15.

The flash memory 16 stores an initial program loader (IPL) which is a program for loading into the RAM 15 a Linux OS (OS: operating system) stored on the memory card 2 (2a), and image information and the like to be displayed on the display unit 3.

The I/O controller 17 is an interface for inputting and outputting information to the controller 12.

The memory card 2a stores a Linux OS, and Linux file system, and sequence program, and library, and device drivers, and version information, and sector information, and sector modification program, and evacuate program, and new version application program. The memory card 2a has an evacuate region 2b as a storage region for temporarily saving analysis-linked information stored in each sector 13a of the BBURAM 13.

The memory card 2 does not store the sector modification program or evacuate program, but does store a Linux OS, and Linux file system, and sequence program, and library, and device drivers, and version information, and sector information, and sector setting program, and application program which is an older version of the application program stored on the memory card 2a. The sector setting program on the memory card 2 is started when sectors have not been set in the storage region 13b of the BBURAM 13, so as to allocate the sectors of the storage region 13b based on the sector information. Specifically, the sector information includes the starting address and ending address of each sector 13a of the storage region 13b. The sector setting program writes the starting address and ending address of each sector 13a included in the sector information to the sector information storage area 13c. Each sector 13a of the storage region 13b shown in FIG. 3 is a sector set by loading the memory card 2.

The application programs stored on the memory card 2 and memory card 2a are used in the analysis of the blood specimen 50. Specifically, the application program operates on a Linux OS, starts the sequence program, processes the digital signals input to the controller 12 from the detection unit 8 to calculate the analysis result, displays the calculated analysis result on the display unit 3, and stores the analysis result in the BBURAM 13.

The Linux OS stored on the memory cards 2 and 2a are operating systems required to start the application program.

The Linux file system stored on the memory cards 2 and 2a is configured by the various information relating to the functions of the Linux OS.

The sequence program stored on the memory cards 2 and 2a control the operation amount and operation timing, such as for the motors and valves included in the detection unit 8, sample preparation unit 9, and washing unit 10 and the like. The sequence program is started by instructions from the application program.

The library stored on the memory cards 2 and 2a includes information such as icons and language for display on the display unit 3.

The device drivers stored on the memory cards 2 and 2a are software for operating the peripheral devices when peripheral devices, such as external printer, external display device and the like, are provided.

The version information (version number) stored on the memory cards 2 and 2a represents the version of the application program stored on the memory card 2 (2a). A larger version number represents a newer version. In the present embodiment, the version information stored on the memory card 2 is [1], and the version information stored on the memory card 2a is [2]. Since the version information is written to the BBURAM 13 by the CPU 14 when, for example, the memory card 2 is loaded in the card loader 6, [1] is stored as the version information in the sector 13a which stores the version information in the BBURAM 13.

The sector information stored on the memory card 2a is information for setting the range of each sector of the storage region 13b when the memory card 2a is loaded in the card loader 6. Specifically, the sector information includes the starting address and ending address of each sector of the storage region 13b.

The sector modification program stored on the memory card 2a is a program for modifying the range of each sector in the storage region 13b of the BBURAM 13 based on the sector information. Specifically, the sector modification program rewrites the sector information written in the sector information storage area 13c (starting address and ending address of each sector) to the sector information stored on the memory card 2a (starting address and ending address of each sector).

The evacuate program saves (evacuates) the analysis-linked information stored in each sector 13a of the BBURAM 13 to the evacuate region 2b of the memory card 2a.

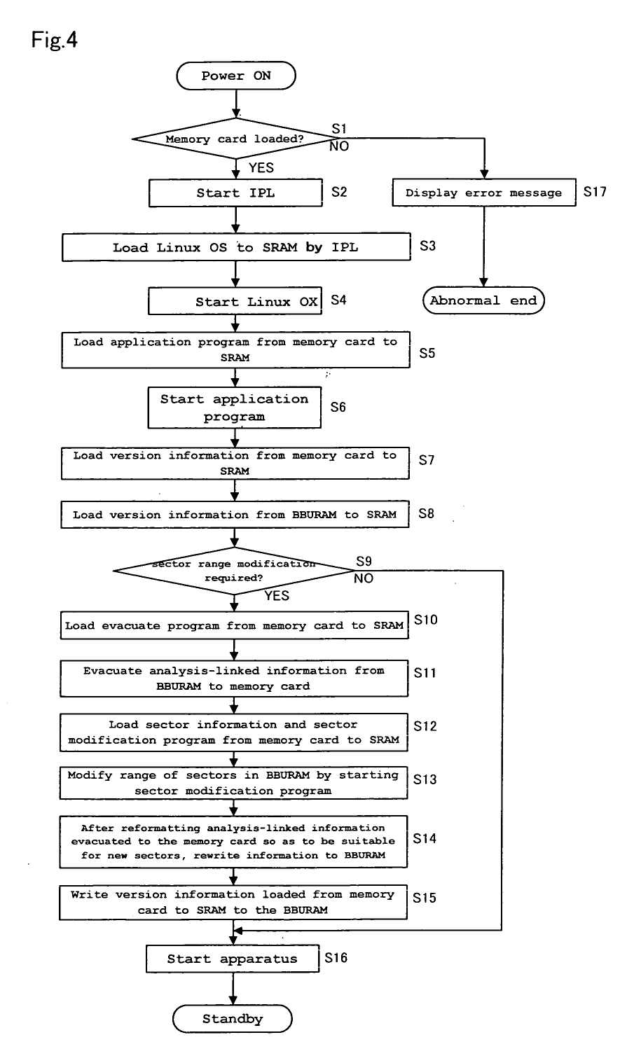

The process executed by the CPU 14 after the user turns ON the power switch 25 until the device body 1 attains the standby state is described below with reference to FIG. 4.

When the user turns ON the power switch 25, a process is executed to determine whether or not a memory card is loaded in the card loader 6 in step S1. When a memory card is not loaded in the card loader 6, then in step S17 a process is executed to output a message to the display unit 3 indicating to switch OFF the power and load a memory card, and the process ends abnormally.

When it is determined in step S1 that a memory card is loaded, then in step S2 the initial program loader (IPL) stored in the flash memory 16 is started. Thereafter, in step S3 the Linux OS is loaded from the memory card based on the initial program loader (IPL). Next, in step S4 the Linux OS is read from the SRAM 15 and started.

Then, in step S5 an application program is loaded from the memory card to the SRAM 15. Thereafter, in step S6 the application program is read from the SRAM 15 and started. Then, in step S7 the version information (version number) is read from the memory card and loaded in the SRAM 15. In step S8 the version information (version number) is read from the BBURAM 13 and loaded in the SRAM 15.

Next, in step S9 a determination is made as to whether or not the range of the sectors 13a in the storage region 13b of the BBURAM 13 must be modified by comparing the version information (version number) loaded from the memory card in step S7 and the version information (version number) loaded from the BBURAM 13 in step S8. Specifically, when the version number loaded from the memory card in step S7 is larger than the version number loaded from the BBURAM 13 in step S8, it is determined that the range of the sectors 13a must be modified; and when the version number loaded from the memory card in step S7 is equal to or smaller than the version number loaded from the BBURAM 13 in step S8, it is determined that the range of the sectors 13a do not require modification.

When, for example, a memory card 2 has been removed from the card loader 6 and the memory card 2a has been loaded therein and the power switch 25 is turned ON for the first time, it is determined that the range of the sectors 13a must be modified because the version number loaded from the BBURAM 13 is [1], and the version number loaded from the memory card 2a is [2].

Conversely, when the power switch 25 is turned ON with the memory card 2 loaded in the memory card loader 6, it is determined that the range of the sectors 13a do not require modification because the version number loaded from the BBURAM 13 and the version number loaded from the memory card 2 are both [1].

When it is determined in step S9 that the range of the sectors 13a must be modified, the process advances to step S10, and when it is determined that the range of the sectors 13a do not require modification in step S9, the process advances to step S16.

In the present embodiment, the advance of the process to step S10 occurs when the memory card 2a is loaded in the card loader 6, and the process of steps S10 to S15 is therefore described with the memory card 2a loaded in the card loader 6.

In step S10, the evacuate program is loaded from the memory card 2a to the SRAM 15. In step S11, the analysis result information (specimen analysis results, quality control information, setting values, reagent replacement log, error log, calibration values, and version information) stored in the BBURAM 13 is saved (evacuated) in the evacuate region 2b of the memory card 2a. In this way loss of analysis-linked information can be prevented when the range of the sectors 13a of the BBURAM 13 is modified. In step S12, the sector information and sector modification program are loaded from the memory card 2a to the SRAM 15.

In step S13, the range of the sectors 13a is modified based on the sector information loaded from the memory card 2a to the SRAM 15 by starting the sector modification program.

Specifically, the sector information (starting address and ending address of the each sector) written to the sector information storage area 13c of the BBURAM 13 is rewritten to the sector information (starting address and ending address of each sector) loaded in the SRAM 15.

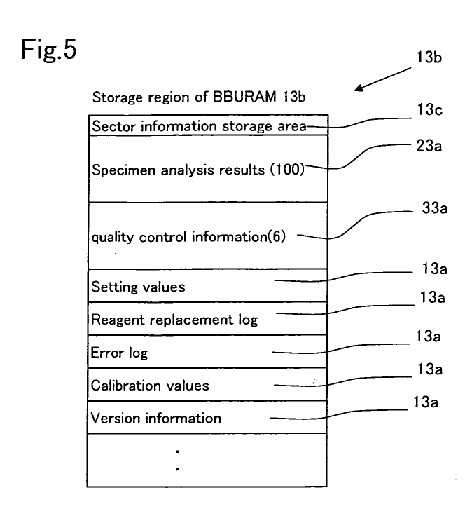

In this way the range of the sectors 23a, 33a, and 13a in the storage region 13b are modified as shown in FIG. 5, and consequently the capacities are increased for the sector 23a for storing the specimen analysis results, and the sector 33a for storing quality control information.

Specifically, the sector 13a (refer to FIG. 3) for storing specimen analysis results of twenty specimens is modified to the sector 23a which has a capacity capable of storing the specimen analysis results of one hundred specimens. Furthermore, the sector 13a (refer to FIG. 3) for storing the analysis results of three types of accuracy management blood specimens measured within a predetermined time period is modified to the sector 33a which has a capacity capable of storing the analysis results of six types of accuracy management blood specimens measured within a predetermined time period.

The range of the sector 13a for storing analysis-linked information (setting values, reagent replacement log, error log, calibration values, and version information) other than specimen analysis results and quality control information is modified so as to start sequentially from the next address following the ending address of the sector 33a. In the present embodiment, the capacities of these sectors 13a are not modified.

In step S14, the analysis-linked information saved in the evacuate region 2b of the memory card 2a in step S11 is modified to a data format suitable for the new modified sectors 23a, 33a, and 13a, and thereafter the analysis-linked information is written to the sectors 23a, 33a, and 13a for each information type.

In step S15, the version information (version number) [2] loaded from the memory card 2a to the SRAM 15 is written to the sector 13a for storing the version information (version number) of the BBURAM 13. In this way the version information (version number) [1] stored in the BBURAM 13 is updated to the version information (version number) [2] stored on the memory card 2a.

Finally, in step S16, the device body 1 of the blood analyzer (refer to FIG. 1) is started. That is, the detection unit 8, sample preparation unit 9, and washing unit 10 and the like are in the standby state. In this way the device body 1 enters the standby state in which it is capable of starting the measurement of blood specimens 50.

In the present embodiment, since the capacity of the sectors 13a can be modified by storing the sector information and the sector modification program for modifying the range of the sectors 13a of the storage region 13b of the BBURAM 13 on the memory card 2a for storing application programs used in the analysis of blood samples 50 as described above, version upgrades of the application program and the amount of storage specimen analysis information and quality control information and the like can be increased.

Furthermore, if the starting address and ending address associated with a sector for storing analysis-linked information of a new type is stored on the memory card 2a as sector information, then the types of analysis-linked information stored in the BBURAM 13 and the version upgrades of the application programs can be increased.

In the present embodiment, since the analysis-linked information is stored for each type of information in the sectors of the storage region 13b of the BBURAM 13, the storage region 13 can be used more effectively compared to when analysis-linked information is stored randomly in the BBURAM 13 and reading information stored using a file system. Therefore, the analyzer can be made more compact and inexpensive.

In the present embodiment, since a determination is made as to whether or not the range of the sectors 13a of the storage region 13b of the BBURAM 13 require modification by comparing the version information (version number) stored on the memory card 2a and the version information (version number) stored in the BBURAM 13, it is possible to modify the range of the sectors 13a only when the version number stored on the memory card 2a is greater than the version number stored on the BBURAM 13. In this way modification of the range of the sectors 13a can be prevented when the range of the sectors 13a does not require modification.

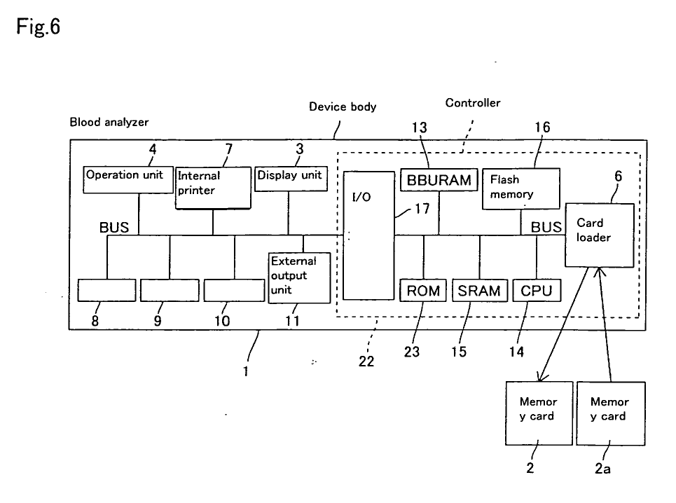

The structure of a blood analyzer which is a modification of the previously described embodiment is described below with reference to FIG. 6.

The blood analyzer of the present modification includes a ROM 23 in the controller 22 as shown in FIG. 6. The ROM 23 is electrically connected to the BBURAM 13, CPU 14, SRAM 15, flash memory 16, I/O controller 17, and card loader 6. Furthermore, the RAM 23 stores a Linux OS and Linux file system required for the operation of the application programs. In this way the Linux OS and Linux file system are not stored on the memory card 2 (2a) used in the present modification. The structure of the blood analyzer of the present modification is in other aspects identical to the structure of the blood analyzer of the previously described embodiment.

In the operation of starting the blood analyzer of the present modification, the Linux OS is loaded from the ROM 23 to the SRAM 15 in step S3 (refer to FIG. 4) in which the Linux OS is loaded in the SRAM 15 by the initial program log (IPL). The operation of the blood analyzer of the present modification is in other aspects identical to the operation of the blood analyzer of the previously described embodiment.

In the blood analyzer of the present modification, the storage capacity required in the memory card 2 (2a) can be reduced by storing the Linux OS and Linux file system required for the operation of the application program in the ROM 23, and not storing the Linux OS and Linux file system on the memory card 2 (2a).

The effect of the blood analyzer of the present modification is in other aspects identical to the effect of the blood analyzer of the previously described embodiment.

The embodiment disclosed herein should not be considered limited to the examples in any aspect. The scope of the present invention is described by the scope of the claims and not by the description of the embodiment, and includes all modifications which are within the scope and equivalences of the accompanying claims.

For example, although in the previously described embodiment, a blood analyzer is used as one example of the sample analyzer of the present invention, the present invention is not limited to a blood analyzer and may also be applied to other sample analyzers, such as urine analyzers and the like.

Although a memory card is used as an example of the external memory of the present invention in the present embodiment, the invention is not limited to this arrangement inasmuch as external memory media other than a memory card may be used as the external memory medium of the present invention. For example, external memory media such as an MO (magneto-optical) device, floppy disk, USB (universal serial bus) memory, hard disk and the like may be used.

Although a BBURAM is used as an example of the internal memory medium of the present invention in the present embodiment, the invention is not limited to this arrangement inasmuch as memory other than BBURAM also may be used.

In the present embodiment a Linux OS and Linux file system are stored on an external memory card, and in the above modification a Linux OS and Linux file system are stored in an internal ROM within the apparatus, however, the present invention is not limited to these arrangements inasmuch as a Linux OS and Linux file system may be stored on a storage medium other than a memory card or ROM. For example, a Linux OS and Linux file system also may be stored in an internal flash memory within the apparatus.

In the present embodiment a Linux OS is used as an operating system program for the operation of the application programs, however, the present invention is not limited to this arrangement inasmuch as operating system programs such as Windows and the like also may be used as the operating system program for the operation of the application programs.

In the present embodiment, only the sector for storing the quality control information and the sector for storing the specimen analysis results in the storage region of the BBURAM are modified to increase their capacity, however, the present invention is not limited to this arrangement inasmuch as the sectors for storing information other than specimen analysis results and quality control information (setting values, reagent replacement log, calibration values, and version information) may also be modified to increase their capacities.

Although the analysis-linked information is evacuated from the BBURAM 13 to the memory card 2a by the evacuate program in the present embodiment, the present invention is not limited to this arrangement inasmuch as the analysis-linked information also may be evacuated to the SRAM 15 and flash memory 16.

Although the device body 1 operates with the memory card 2 (2a) loaded in the card loader 6 in the present embodiment, the present invention is not limited to this arrangement inasmuch as all information stored on the memory card 2a also may be copied (installed) on an internal memory medium such as the flash memory 15 when the memory card 2a is loaded in the memory loader 6 and the power switch 25 is first turned ON. In this way the device body 1 can be operated even when the memory card 6 is not installed.

Although the embodiment has been described in terms of upgrading the version [1] application program to version [2], when a version upgrade of the application program is necessary, a memory card storing the new version [2] application program and new sector information may be installed in the card loader 6 rather than the memory card 2 if the power source of the device body is turned ON.

Although the present embodiment has been descried in terms of a version upgrade of an application program, the present invention is not limited to this arrangement inasmuch as a Linux OS newer than the Linux OS stored on the memory card 2 also may be stored on the memory card 2a. In this way the version of the operating system can be upgraded.

1. A sample analyzer, comprising:
an internal memory installed within a device body and which includes a storage region including a sector for storing predetermined type of information related to an analysis of sample; and
an external memory removably installed from outside the device body, for storing a program used in the analysis of sample, and sector modification information for modifying the range of the sector in the storage region.

2. The sample analyzer of claim 1, wherein the program comprises an application program used in the analysis of sample.

3. The sample analyzer of claim 1, wherein the program comprises an operating system necessary for the operation of the application program used in the analysis of sample.

4. The sample analyzer of claim 2, further comprising:
a second internal memory installed within the device body, for storing an operating system necessary for the operation of the application program.

5. The sample analyzer of claim 2, wherein the information related to the analysis of sample comprises an analysis result obtained by analyzing sample using the application program.

6. The sample analyzer of claim 2, wherein the internal memory stores a first version information representing a version of an application program installed in the sample analyzer, the external memory stores a second version information representing the version of the application program stored in the external memory,
and the sample analyzer further comprises a modification determining means for determining whether or not to modify the range of the sector in the storage region by comparing the first version information and the second version information.

7. The sample analyzer of claim 6 further comprising:
a version updating means for updating the first version information stored on the internal memory to the second version information when the modification determining means determines that the range of the sector is to be modified.

8. The sample analyzer of claim 1, wherein the sector modification information comprises sector information representing the range of the sector in the storage region, and a sector modification program for modifying the range of the sector in the storage region based on the sector information.

9. The sample analyzer of claim 1 further comprising:
a loading means for loading the sector modification information from the external memory; and a third memory installed within the device body, for temporarily storing the sector modification information loaded from the external memory.

10. The sample analyzer of claim 8, wherein the storage region includes a sector information storage area for storing a second sector information representing the range of the sector in the storage region; and
the sector modification program is a program for rewriting the second sector information stored in the sector information storage area to the sector information.

11. The sample analyzer of claim 1, wherein the external memory comprises a memory card for storing the program used in the analysis of sample, and the sector modification information.

12. The sample analyzer of claim 1, wherein the internal memory comprises a battery back-up RAM which includes the storage region.

13. An external memory removably installed from outside a sample analyzer which comprises an internal memory that includes a first storage region including a sector for storing a predetermined kind of information related to an analysis of sample,the external memory comprising:
a second storage region for storing a program related to the analysis of sample, and sector modification information for modifying the range of the sector in the first storage region.

14. The external memory of claim 13, wherein the sector modification information includes sector information representing the range of the sector in the first storage region, and a sector modification program for modifying the range of sector in the first storage region based on the sector information

15. The external memory of claim 13, wherein the second storage region further stores a evacuate program for evacuating the information stored on the internal memory to another memory.

16. The external memory of claim 15, wherein the evacuate program evacuates the information stored in the first storage region to the another memory before modifying the range of the sector based on the sector modification information, and writes the information evacuated to the another memory to the first storage region after modifying the range of the sector based on the sector modification information.

17. A sample analyzer comprising:
an internal memory installed within a device body, for storing information related to an analysis of sample; and
an external memory removably installed from outside the device body, for storing a program related to the analysis of sample, and a evacuate program for evacuating the information stored on the internal memory to another memory.

18. The sample analyzer of claim 17, wherein the internal memory includes a storage region including a sector for storing a predetermined type of information relating to an analysis of sample;
the external memory further stores sector modification information for modifying a range of the sector in the storage region; and
the evacuate program evacuates the information stored in the storage region to another memory before modifying the range of the sector based on the sector modification information, and writes the information evacuated to the another memory to the storage region after modifying the range of the sector based on the sector modification information.

19. The sample analyzer of claim 17, wherein the another memory is the external memory.

20. The sample analyzer of claim 19, wherein the external memory includes a evacuate region for storing the information evacuated from the internal memory.
